(19) United States
(12) Patent Application Publication
(10) Pub. No.: US 2015/0177641 A1
(43) Pub. Date: Jun. 25, 2015

(54) IMAGE FORMING APPARATUS

(71) Applicant: CANON KABUSHIKI KAISHA, Tokyo (JP)

(72) Inventor: Yoshiro Tsukada, Munich (DE)

(21) Appl. No.: 14/572,659

(22) Filed: Dec. 16, 2014

(30) Foreign Application Priority Data
Dec. 25, 2013 (JP) 2013-267131

(51) Int. Cl. G03G 15/08

(52) U.S. Cl. CPC G03G 15/06

(57) ABSTRACT

A developing sleeve is configured to be driven separately from a conveyance screw facing a developer discharge port for discharging a developer. When the driving speed of the developing sleeve is changed, the rotational speed ratio of conveyance members respectively disposed in a developing chamber and an agitation chamber is changed accordingly.

### BACKGROUND OF THE INVENTION

1. Field of the Invention

The present invention relates to an image forming apparatus, such as a copying machine and a laser beam printer, for developing an electrostatic image formed on an image bearing member based on the electrostatic recording process or the electrophotographic process using a developer containing toner and a carrier.

2. Description of the Related Art

In the conventional dry developing process, the two-component developing process, in which non-magnetic toner and a magnetic carrier are mixed and used as a developer, has been widely used.

While two-component developing process has advantages, such as the stability of image quality and apparatus durability, in comparison with other developing processes currently proposed, the two-component developing process unavoidably causes degradation of the developer due to long-term use, especially degradation of the carrier.

For this reason, there has been proposed a developing device capable of suppressing degradation of the charging performance. In this developing device, a developer composed of two components, namely a carrier and toner, is supplied into a developer container, and a deteriorated developer having degraded charging performance is discharged from the developer container.

For example, Japanese Patent Application Laid-Open No. 11-212346 discusses a technique for supplying a new carrier into a developer container aside from toner for replenishing consumed toner. Further, the technique discharges excess developer in the developer container due to the replenishment, from a discharge port provided in the developer container, to maintain a constant developer amount in the developer container. Processes of supplying a carrier-containing developer and discharging the excess developer are repeatedly performed in this way, thereby replacing old developer with new one in the developer container. This processes maintain the charging performance of the developer to suppress image quality degradation.

In some cases, in the vicinity of the above-described discharge port, the developer splashes by blades of an agitation member, whereby the developer may be excessively discharged. For this reason, Japanese Patent Application Laid-Open No. 2012-234217 discusses a method for omitting blades of an agitation member only in the vicinity of the above-described developer discharge port.

FIGS. 1A and 1B schematically illustrate the particle surface of the developer when blades of an agitation member 5 are partially omitted.

Referring to FIGS. 1A and 1B, when the agitation member 5 has the configuration in which blades are omitted only in the vicinity of a developer discharge port 13, the particle surface is temporarily raised in comparison with other peripheral portions where blades are provided.

FIG. 2A illustrates a relation between the moving speed of the developer and the particle surface for the agitation member 5 with no blade omitted. FIG. 2B illustrates a relation between the moving speed of the developer and the particle surface for the agitation member 5 with blades partially omitted. As a method for measuring the moving speed of the developer, a FASTCAM high-speed camera from Photron is employed to capture the movement of the developer with a high frame rate, and then to track each individual particle using image processing software, thereby automatically calculating the moving speed of the developer.

It turns out that, in the area where blades are partially omitted, the moving speed of the developer temporarily decreases. The moving speed decreases simply because blades for pushing the developer are partially omitted, and hence the force for pushing the developer forward is lost.

As a result, the developer temporarily stagnates at the portion, and a particle surface T becomes higher than peripheral portions.

Japanese Patent Application Laid-Open No. 2012-234217 discusses a technique for discharging excess developer by utilizing this phenomenon while preventing the developer from splashing by blades.

Some image forming apparatuses have a plurality of operating speeds.

For example, paper having a larger grammage draws a larger amount of heat from a fixing unit. Therefore, the operating speed is generally changed to a lower speed for paper having a larger grammage.

When the image forming apparatus operates at a plurality of operating speeds in this way in order to cope with thick paper or the like, the driving speeds of a photosensitive drum and a developing unit involved in image formation generally change according to the change rate of the operating speed of the main body.

This means that, when the operating speed of the main body changes, the speed of the agitation member of the developing unit is generally changed in a similar way. The reason for the speed change is as follows: when the operating speed of the main body (image forming speed) is changed, the peripheral speed of the photosensitive drum is changed accordingly. In this case, failure to change the peripheral speed of a developing sleeve according to the peripheral speed of the photosensitive drum increases the peripheral speed ratio between the photosensitive drum and the developing sleeve, resulting in an image defect. Further, the driving speed of the developing device is changed according to the operating speed of the main body since an unnecessarily high rotational speed of the developing sleeve may cause degradation of the developer.

In this case, in the agitation member with blades omitted only in the vicinity of the above-described developer discharge port, the following has been known about moving speeds of the developer in the areas having blades (hereinafter referred to as blade portions) and the area having no blades (hereinafter referred to as a non-blade portion).

FIG. 3 illustrates moving speeds of the developer at the blade portions and the non-blade portion of the agitation member 5 for three different rotational speeds of the agitation member 5. When the rotational speed of the agitation member 5 is reduced from the normal speed to the half speed and the ⅓ speed, the moving speed of the developer in the vicinity of the blade portions is halved and becomes one third, respectively, according to the speed of the agitation member 5. However, the moving speed of the developer in the area where blades are partially removed remains almost unchanged though the moving speed slightly decreases as the rotational speed is reduced.

At the blade portions, the movement of the developer depends on the rotational speed of the agitation member 5. At the non-blade portion, however, the movement of the developer does not largely depend on the rotational speed of the agitation member 5 since the developer moves with a force according to inertia force and frictional force between developer particles. This phenomenon is seen not only in a case where blades are completely removed but also in a case where the blade diameter or the distance between blade pitches is extremely reduced to degrade the conveyance capability in the rotational axis direction of the agitation member 5.

FIG. 4 illustrates developer particle surface states at the blade portions and the non-blade portion of the agitation member 5 for three different rotational speeds of the agitation member 5. While the particle surface at the non-blade portion rises with respect to the peripheral portions at the normal speed (600 rpm), as the rotational speed of the agitation member 5 decreases to the ½ speed (300 rpm) and then to ⅓ speed (200 rpm), the difference in the particle surface height between the non-blade portion and the peripheral portions decreases. This is because, as described above, the difference in the moving speed of the developer between the blade areas and the non-blade area decreases to become unnoticeable as the rotational speed of the agitation member 5 decreases.

In a case where the method of omitting blades of the agitation member 5 only in the vicinity of the developer discharge port 13 is employed, when the rotational speed of the agitation member 5 is intentionally decreased, the particle surface T in the vicinity of the developer discharge port 13 is lowered, making it difficult to discharge the developer which needs to be discharged.

FIG. 5 illustrates a developer circulation configuration of a function-separated type developing unit. The function-separated type developing unit has a mechanism for collecting the developer, which is supplied from a developing chamber 3 to a developer bearing member 8, into an agitation chamber 4.

The developer circulation in a vertical agitation function-separated type developing unit has three different functions: a function A for scooping up the developer from the agitation chamber 4 into the developing chamber 3 against gravity, a function B for dropping the developer from the developing chamber 3 into the agitation chamber 4, and a function C for moving the developer from the developing chamber 3 into the agitation chamber 4 by the developer bearing member 8.

In such a function-separated configuration, if the image forming speed is changed, the speed of the developer bearing member 8 is changed, resulting in a change in the circulation balance of the developer in the developing device. Therefore, to maintain the circulation balance, it is necessary to change the speed of the conveyance member (the agitation member) in the developing device.

However, as described above, there arises a problem that changing the speed of the conveyance member degrades the dischargeability.

### SUMMARY OF THE INVENTION

The present invention is directed to a developing device including a discharge port for discharging a developer, and a conveyance member having no blades or having small-diameter blades at a discharge port counter portion, and having separated functions of supplying the developer and collecting the developer to/from a developer bearing member, the developing device capable of suppressing a decrease in the dischargeability of the developing device even if the driving speed of the developing device is changed.

According to an aspect of the present invention, an image forming apparatus capable of executing a first mode in which an image forming speed is a first speed, and a second mode in which an image forming speed is a second speed lower than the first speed, includes an image bearing member rotatably disposed, and configured to bear an image; a developer bearing member rotatably disposed, and configured to bear a developer containing toner and a carrier to develop a latent image formed on the image bearing member; a first chamber configured to supply the developer to the developer bearing member at a position facing the developer bearing member; a second chamber connected with the first chamber to form a circulation path for circulating the developer between the first and second chambers, and configured to collect the developer from the developer bearing member at a position facing the developer bearing member; a partition wall separating the first and the second chambers; a discharge port configured to discharge the developer in a developing device; a first conveyance member rotatably disposed in the first chamber so as to face the discharge port, and configured to convey the developer in the first chamber, wherein the first conveyance member has no blade in an area corresponding to the discharge port, or a diameter of blades in the area is smaller than that of blades in front and rear areas in a conveyance direction; a second conveyance member rotatably disposed in the second chamber, and configured to convey the developer in the second chamber; a first drive source configured to drive the first conveyance member; a second drive source configured to drive the second conveyance member; and a control unit configured to control the first and the second drive sources so that, when the first mode is changed to the second mode, a speed change amount of the first conveyance member is smaller than a speed change amount of the second conveyance member.

Further features of the present invention will become apparent from the following description of exemplary embodiments with reference to the attached drawings.

### BRIEF DESCRIPTION OF THE DRAWINGS

FIGS. 1A and 1B illustrate a relation between blades of an agitation member and a particle surface.

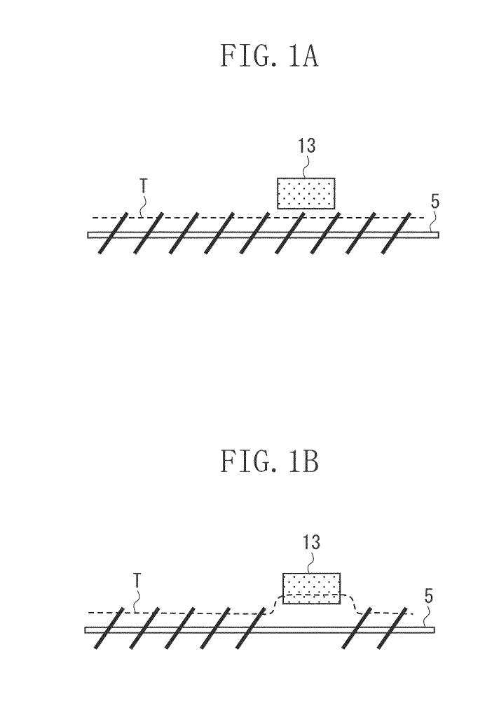

FIGS. 2A and 2B illustrate a relation between blades of the agitation member, and a particle surface and a moving speed of a developer.

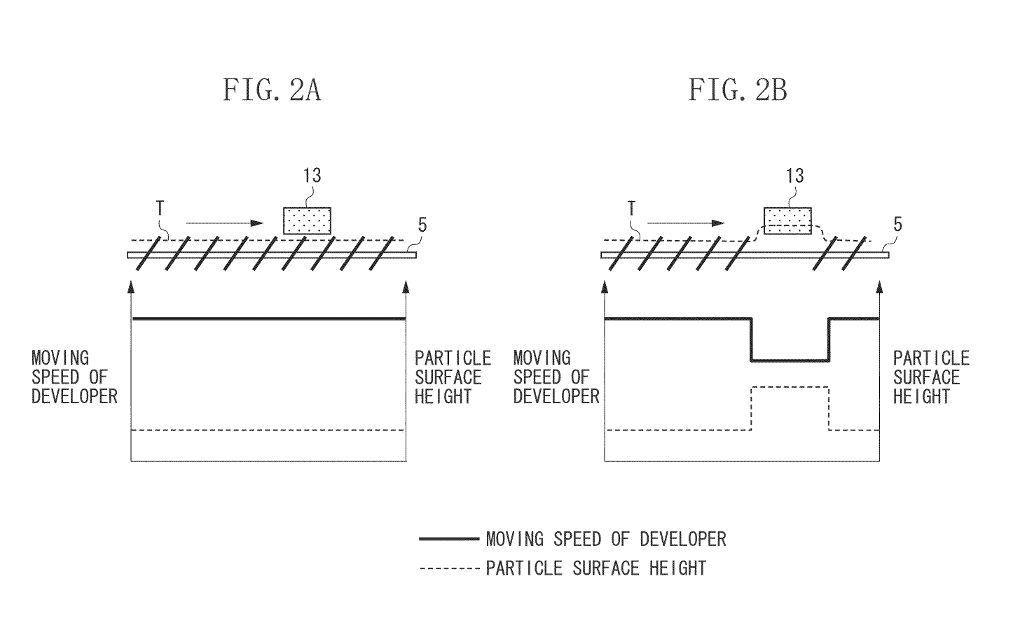

FIG. 3 illustrates a relation between a rotational speed of the agitation member and a moving speed of the developer.

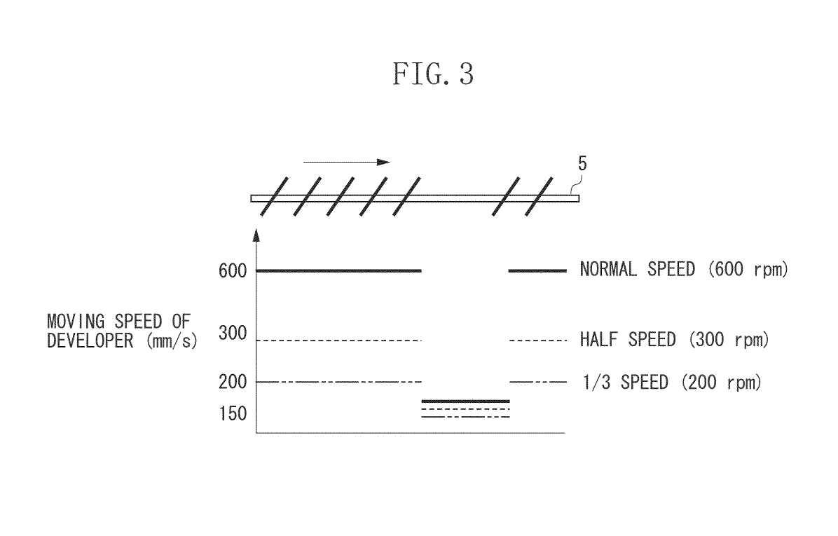

FIG. 4 illustrates a relation between a rotational speed of the agitation member and a particle surface.

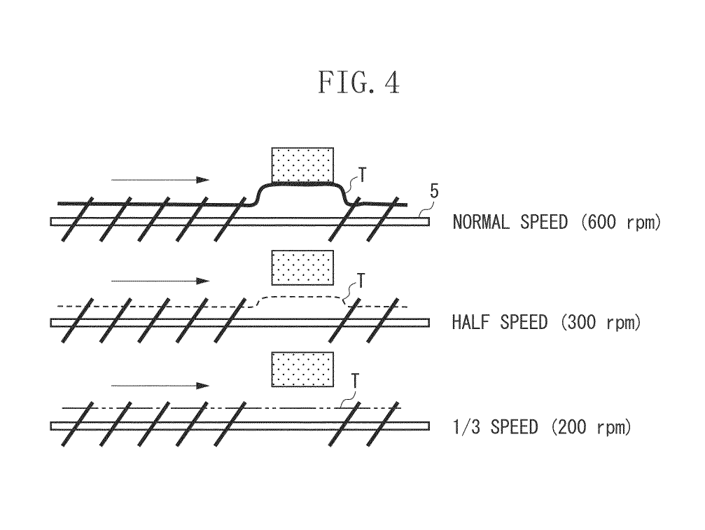

FIG. 5 schematically illustrates a vertical agitation type developing unit.

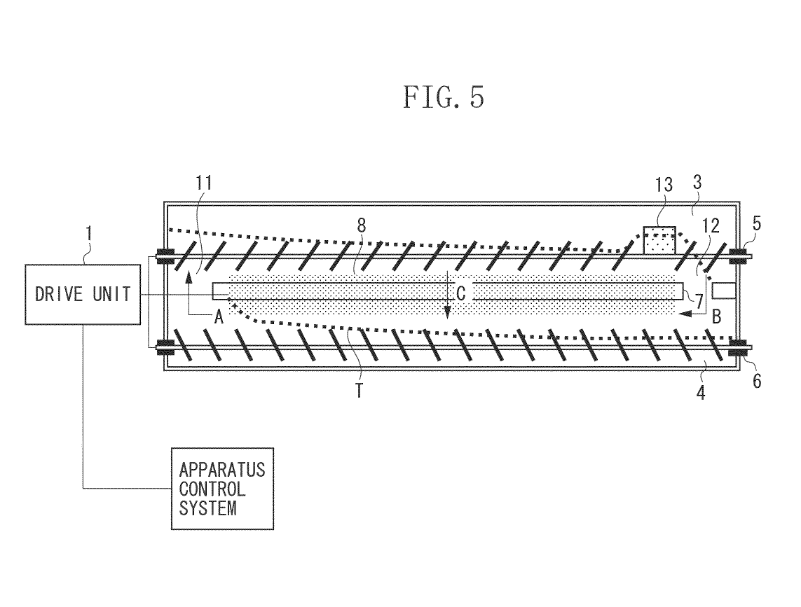

FIG. 6 schematically illustrates an image forming apparatus.

FIG. 7 is a sectional view illustrating the vertical agitation type developing unit.

FIG. 8 illustrates a particle surface state at a normal speed.

FIG. 9 illustrates a relation between a grammage and a sheet-passing speed.

FIG. 10 illustrates a table indicating a sheet-passing speed and a driving speed of each member.

FIG. 11 illustrates an arrangement of development drive sources according to a first exemplary embodiment.

FIG. 12 illustrates a table indicating development driving speed values according to the first exemplary embodiment.

FIG. 13 illustrates an effect according to the first exemplary embodiment.

FIG. 14 illustrates a table indicating driving speed values at a ⅓ speed, according to the first exemplary embodiment.

FIG. 15 illustrates an effect at the ⅓ speed, according to the first exemplary embodiment.

FIG. 16 illustrates an arrangement of development drive sources according to a second exemplary embodiment.

FIG. 17 illustrates a table indicating development driving speed values according to the second exemplary embodiment.

FIG. 18 illustrates an effect according to the second exemplary embodiment.

### DESCRIPTION OF THE EMBODIMENTS

Various exemplary embodiments, features, and aspects of the invention will be described in detail below with reference to the drawings.

In the first exemplary embodiment, a developing device is used in an image forming apparatus described below, for example. The configuration is, however, not limited thereto. The present exemplary embodiment is also applicable to a developing device employing the electrostatic recording process.

### [Image Forming Apparatus]

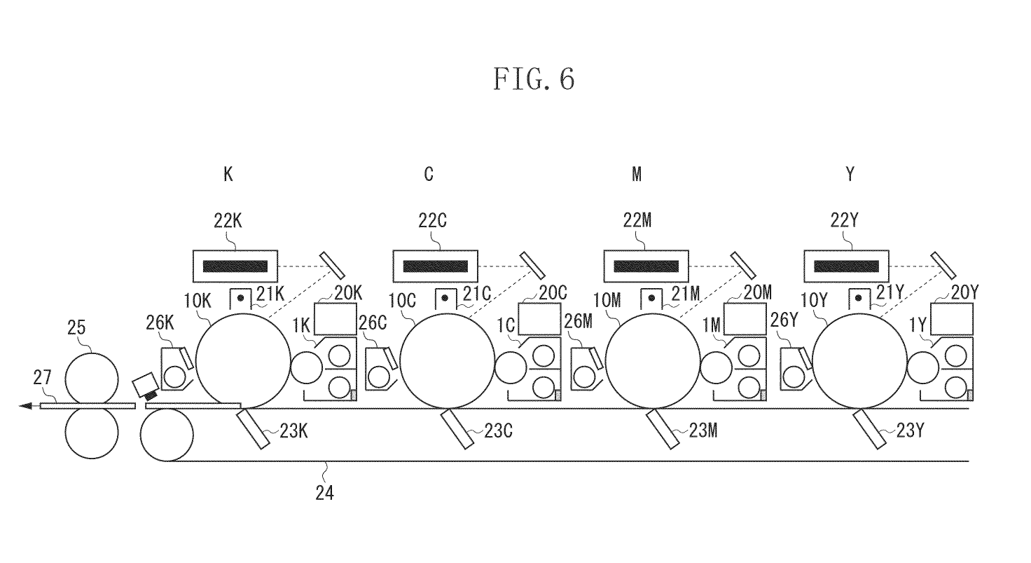

FIG. 6 illustrates Y, M, C, and K stations in a full color image forming apparatus. The Y, M, C, and K stations, which have almost the same configurations, respectively form yellow (Y), magenta (M), cyan (C), and black (K) images in a full-color image.

In the following descriptions, for example, a developing device 1 commonly refers to a developing device 1Y, a developing device 1M, a developing device 10, and a developing device 1K in the respective Y, M, C, and K stations. The other members provided in the respective M, C, Y, and K stations are indicated in a similar way.

FIG. 6 illustrates operations of the entire image forming apparatus.

A photosensitive drum 10 is rotatably provided as an image bearing member. The photosensitive drum 10 is uniformly charged by a primary charging unit 21, and exposed to light modulated by a light emitting element 22 such as laser according to an information signal, so that an electrostatic latent image (simply referred to as a latent image) is formed on the photosensitive drum 10. The latent image is visualized as a toner image by the developing device 1 through a development process described below.

Then, the visible image is transferred by a transfer charging unit 23 onto a transfer sheet 27 conveyed by a transfer sheet conveyance sheet 24, and fixed thereon by a fixing device 25, so that a permanent image is obtained. In addition, a residual transfer developer on the photosensitive drum 10 is removed by a cleaning unit 26. Furthermore, toner is supplied from a toner hopper 20 functioning as a toner replenishing tank to replenish the developer (toner) consumed by image formation.

### [Developing Device]

The developing device 1 according to the present exemplary embodiment uses a two-component developer containing non-magnetic toner and a low-magnetization high-resistance carrier, as described below.

The non-magnetic toner includes appropriate amounts of binder resin such as styrene resin and polyester resin, coloring agents such as carbon black, dye, and pigment, release agents such as wax, and charging control agents. Such non-magnetic toner can be manufactured by a common method such as a grinding method and a polymerization method.

As a magnetic carrier, conventionally-known carriers can be used. Examples of such carriers include resin carriers made by dispersing magnetite as a magnetic material in resin and dispersing carbon black to provide conductivity and adjust resistance, carriers made by oxidizing and reducing the surface of simple substance magnetite such as ferrite to adjust resistance, and carriers made by coating the surface of simple substance magnetite such as ferrite with resin to adjust resistance. The method for manufacturing these magnetic carriers is not especially limited.

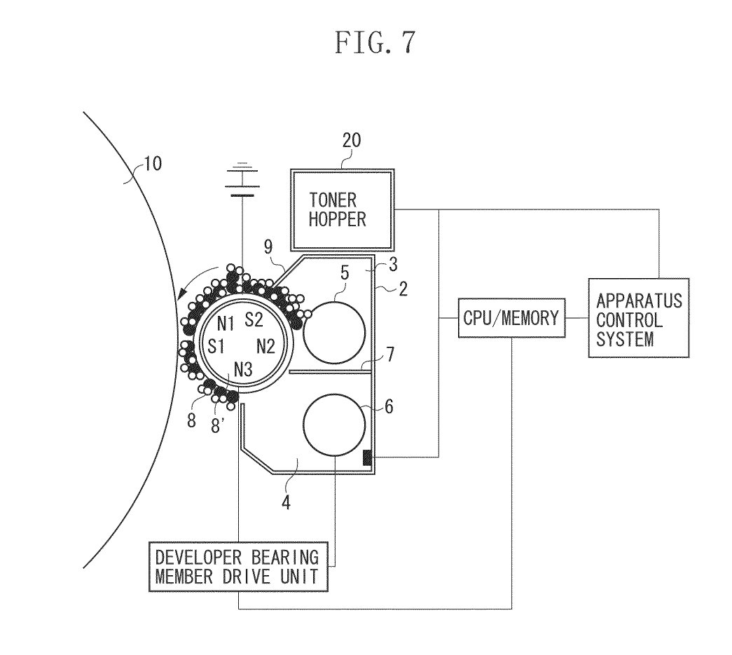

Next, operations of the developing device 1 according to the present exemplary embodiment will be described below with reference to FIG. 7. A developer container 2 containing the above-described developer includes a developing sleeve 8 as a developer bearing member, and an ear-cutting member 9 (a regulating member) supported on the developing sleeve 8 and configured to control ears of the developer.

In addition, the above-described developer container 2 is provided with an opening at a position equivalent to a development portion facing the photosensitive drum 10. The developing sleeve 8 is rotatably disposed at the opening so that the developing sleeve 8 is partially exposed toward the photosensitive drum 10. The developing sleeve 8 is made of a non-magnetic material. A magnet roller 8′ serving as a magnetization unit is unrotatably disposed in the developing sleeve 8. The magnet roller 8′ has a development pole S1 located at the development portion, and magnetic poles S1, N1, S2, N2, and N3 for conveying the developer.

It is desirable that a non-magnetic cylinder of the developing sleeve 8 is made of a conductive material. Such a material may be selected from various conventionally-known materials including metals such as stainless steel and aluminum, and resin member provided with conductivity by dispersing conductive particles. The developing sleeve 8 may be processed. For example, the surface thereof may be roughened through blast processing to improve developer conveyance property.

During development, the developing sleeve 8 rotates in the direction indicated by an arrow illustrated in FIG. 7, bears the two-component developer the layer thickness of which is controlled by cutting magnetic brush ears by the ear-cutting member 9, and conveys the developer to the development portion facing the photosensitive drum 10. Then, the developing sleeve 8 supplies the developer to a latent image formed on the photosensitive drum 10 to develop the latent image. At this time, to increase the development efficiency (i.e., the rate of toner applied to the latent image), a development bias voltage, in which a direct current (DC) voltage and an alternating current (AC) voltage are superimposed, is applied from a power source to the developing sleeve 8.

The ear-cutting member 9, which is made of a non-magnetic material such as aluminum, is disposed on the upstream side of the photosensitive drum 10 in the rotational direction of the developing sleeve 8. Then, both the non-magnetic toner and the magnetic carrier of the developer pass through between a leading edge portion of the ear-cutting member 9 and the developing sleeve 8, and are conveyed to the development portion. Adjusting the gap between the ear-cutting member 9 and the surface of the developing sleeve 8 controls the cutting amount of magnetic brush ears of the developer borne on the developing sleeve 8, thereby adjusting the developer amount to be conveyed to the development portion.

The developing device 1 according to the present exemplary embodiment is what is called a function-separated type developing device. The developing device 1 includes a developing chamber 3 for supplying the developer to the developing sleeve 8 at a position facing the developing sleeve 8, and an agitation chamber 4 for collecting the developer from the developing sleeve 8 at a position facing the developing sleeve 8. At the substantially-central portion, the developer container 2 is vertically divided into the developing chamber 3 as the upper chamber and the agitation chamber 4 as the lower chamber by a partition wall 7 extending perpendicularly to paper. The developing chamber 3 and the agitation chamber 4 are connected with each other at both ends thereof to form a circulation path for circulating the developer between the developing chamber 3 and the agitation chamber 4.

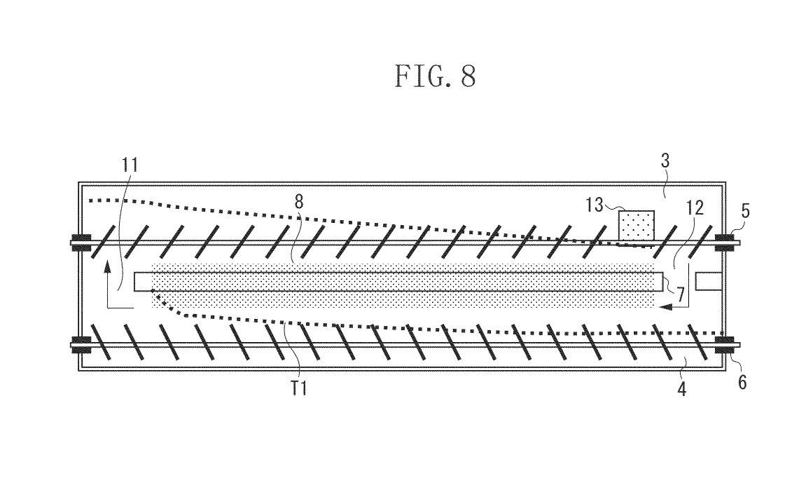

Next, a developer circulation according to the present exemplary embodiment will be described below. FIG. 8 is a sectional view illustrating a developing unit and a developer surface (a particle surface) T1.

For the purpose of developer agitation and conveyance, a first conveyance screw 5 (a first conveyance member) and a second conveyance screw 6 (a second conveyance member) are respectively disposed in the developing chamber 3 and the agitation chamber 4.

In the present exemplary embodiment, the first conveyance screw 5 has a screw structure including a rotational shaft made of a ferromagnetic material, and blade members made of a non-magnetic material spirally arranged around the rotational shaft. The first conveyance screw 5 is disposed at the bottom of the developing chamber 3 (upper chamber) substantially in parallel with the axis direction of the developing sleeve 8, and rotates to convey the developer in the developing chamber 3 in one direction along the axis line direction.

Similar to the first conveyance screw 5, the second conveyance screw 6 has a screw structure including a rotational shaft, and blade members spirally arranged around the rotational shaft in the direction opposite to the blade members of the first conveyance screw 5. The second conveyance screw 6 is disposed at the bottom of the agitation chamber 4 (lower chamber) substantially in parallel with the first conveyance screw 5, and rotates in the same direction as the first conveyance screw 5 to convey the developer in the agitation chamber 4 in the direction opposite to the first conveyance screw 5.

In this way, when the first conveyance screw 5 and the second conveyance screw 6 rotate, the developer is conveyed within the developing chamber 3 and the agitation chamber 4, respectively, and then circulated through openings (communication portions) 11 and 12 provided at both ends in the developer container.

At this time, the developer is delivered from the agitation chamber 4 to the developing chamber 3 in such a manner that the developer is pushed up from bottom to up by the pressing force of the developer accumulated at the scooping-up portion (opening) 11.

In the developing chamber 3 (upper chamber), while conveying the developer conveyed from the agitation chamber 4 (lower chamber) in the circulation direction, the first conveyance screw 5 supplies a part of the developer currently being conveyed to the developing sleeve 8. The developer supplied to the developing sleeve 8 is regulated by the regulating member (ear-cutting member) 9, and conveyed to the development portion, which is a counter portion facing the photosensitive drum 10, so that the latent image on the image bearing member is developed using the toner. The developer in the carrier-rich state due to toner consumption is returned to the agitation chamber 4 by the rotation of the developing sleeve 8.

In the developing chamber 3, a developer discharge port 13 for discharging excess developer is disposed on the downstream side of the first conveyance screw 5. The developer discharge port 13 is configured such that, when the developer amount increases and the particle surface T1 reaches the developer discharge port 13, the excessive portion of the developer is cut and discharged through the discharge port 13.

The first conveyance screw 5 has no blades only in the vicinity of the developer discharge port 13 as a measure for preventing developer from being excessively discharged due to the splash of the developer.

### [Image Forming Speed]

Characteristic configurations according to the present exemplary embodiment will be described below.

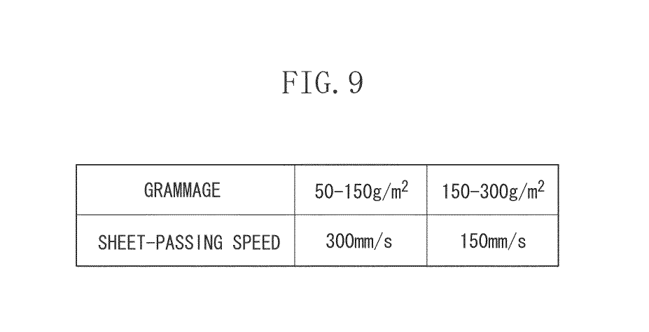

FIG. 9 illustrates a relation between a grammage of paper and a driving speed (an image forming speed) of the main body according to the present exemplary embodiment.

The image forming apparatus according to the present exemplary embodiment is provided with two different paper output speeds (image forming speeds) according to the grammage of paper or the like. In other words, in the present exemplary embodiment, image formation can be performed at different image forming speeds. The image forming apparatus can execute an image forming mode in which an image forming speed is relatively high (a normal speed mode), and an image forming mode in which an image forming speed is relatively low (a low speed mode).

When the grammage of paper is larger than 150 g/m², the paper output speed decreases. Since paper having a large grammage draws a large amount of heat because of the heat capacity of the fixing unit, the paper output speed is reduced. Accordingly, the speed of the image forming engine, such as the developing unit and the photosensitive drum, similarly changes.

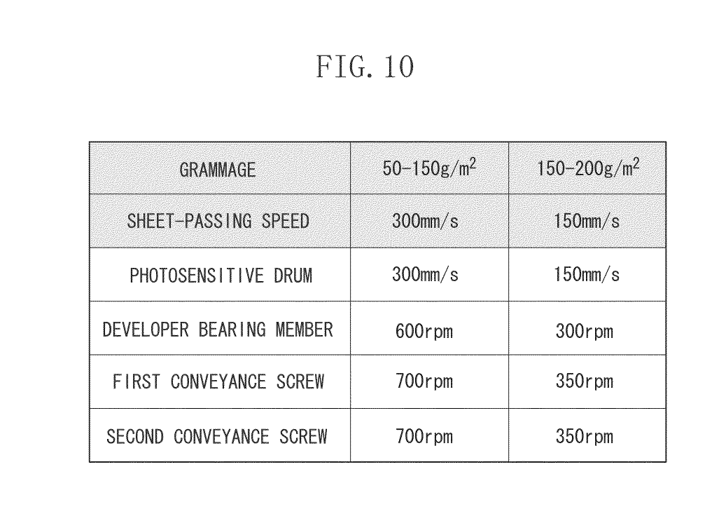

FIG. 10 illustrates a relation between a sheet-passing speed of the main body, and a photosensitive drum speed and development driving speeds of the respective driving members in a common image forming apparatus. When the sheet-passing speed is halved, the speeds of the photosensitive drum 10, the developer bearing member 8, the first conveyance screw 5, and the second conveyance screw 6 are also halved accordingly.

The photosensitive drum 10 is driven in contact with the transfer sheet conveyance sheet 24, as illustrated in the schematic view of the main body in FIG. 6. Therefore, it is necessary to match the driving speed of the photosensitive drum 10 with the moving speed of paper, that is, the sheet-passing speed.

If the developing device is driven at high speed when the sheet-passing speed of the main body is low, the degradation of the developer will progress accordingly. So, in particular, the speed of the developing sleeve 8, which contributes to the degradation of the developer, needs to be similarly reduced according to the sheet-passing speed. Further, if the speed of the developing sleeve 8 is fixed regardless of the image forming speed, the peripheral speed ratio between the photosensitive drum 10 and the developing sleeve 8 increases too much, resulting in an image defect. Therefore, the speed of the developing sleeve 8 is changed along with the speed change of the photosensitive drum 10. As a result, it is common to change the driving speeds of the photosensitive drum 10 and development driving speeds according to the sheet-passing speed, as illustrated in FIG. 10.

However, if the developing unit is driven at low speed, the particle surface is lowered, as described above, and a problem of difficulty in developer discharge will arise. This problem becomes noticeable particularly in the case of the vertical agitation function-separated configuration as in the present exemplary embodiment, and in a case where the first conveyance screw 5 has no blades in the vicinity of the developer discharge port 13.

For this reason, the present exemplary embodiment proposes a developing device configuration in which the above-described problem does not arise even if the sheet-passing speed of the main body is lowered.

In this case, it is desirable that the developer amount in the developer container is consistently substantially-constant. Therefore, it is desirable that the problem that the developer is not discharged in the low speed mode is solved and that the discharged developer amount is close to that at the original speed (300 mm/s). In other words, it is important that the particle surface state in the developer container remains unchanged as much as possible when the image forming apparatus is operated in the low speed mode.

Generally, in most developing devices, the developer bearing member 8 and the agitation screws 5 and 6 (the first and second conveyance screws 5 and 6) are all operated by the same single drive source. Nevertheless, in a case where all of these members are operated by the same single drive source, when the sheet-passing speed of the main body changes, the development driving speed needs to be changed accordingly and therefore the above-described problem arises.

### [Drive Mechanism of Developing Device]

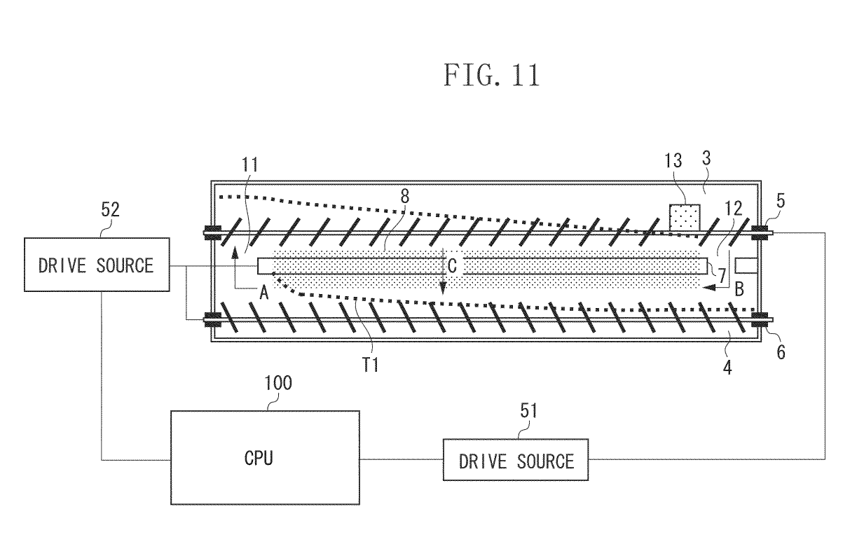

For this reason, the developing device according to the present exemplary embodiment uses a configuration as illustrated in FIG. 11.

In the present exemplary embodiment, the developing unit is driven by two different drive sources. More specifically, as illustrated in FIG. 11, the developing unit according to the present exemplary embodiment includes a drive source 51 for driving the first conveyance screw 5, and a drive source 52 for driving the developing sleeve 8 and the second conveyance screw 6. The developing unit further includes a central processing unit (CPU) 100 as a control unit for controlling the drive sources 51 and 52. In other words, the first conveyance screw 5 (one conveyance member) disposed at a position facing the developer discharge port 13 can be driven separately from the second conveyance screw 6 (the other conveyance member) and the developing sleeve 8.

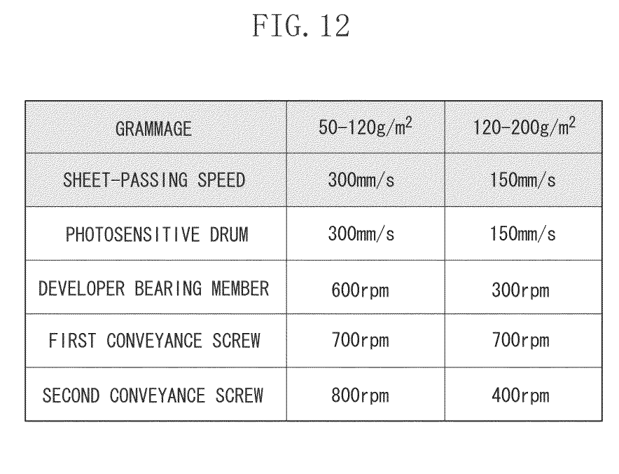

FIG. 12 illustrates a table indicating development driving speed values according to the present exemplary embodiment.

As illustrated in FIG. 12, as the sheet-passing speed of the main body is halved, the CPU 100 performs control to reduce the speeds of the developing sleeve 8 and the second conveyance screw 6 with the same ratio. On the other hand, in the present exemplary embodiment, the CPU 100 consistently maintains the driving speed of the first conveyance screw 5 at 700 rpm.

Since the driving speed of the first conveyance screw 5 is consistently maintained constant regardless of the sheet-passing speed, the difference in speed between the blade portions and the non-blade portion of the first conveyance screw 5 does not change according to the sheet-passing speed. FIG. 11 illustrates the particle surface balance according to the present exemplary embodiment.

When the sheet-passing speed is changed from 300 mm/s to 150 mm/s, the driving speed of the developing sleeve 8 decreases, reducing the amount of developer movement (indicated by an arrow C) from the developing chamber 3 to the agitation chamber 4 by the developing sleeve 8. Therefore, if the driving speeds of the first conveyance screw 5 and the second conveyance screw 6 are maintained constant, the developer amount in the developing chamber 3 increases and the developer amount in the agitation chamber 4 decreases.

In the conventional configuration, the driving speeds of the first conveyance screw 5 and the second conveyance screw 6 are uniformly reduced to maintain the circulation balance. Therefore, when the rotational speed of the first conveyance screw 5 decreases, the developer surface in the developing chamber 3 in which the developer discharge port 13 is provided is lowered, resulting in degradation of dischargeability. In view of the foregoing, in the present exemplary embodiment, as the overall particle surface balance of the developer, even if the sheet-passing speed is changed to 150 mm/s, the first conveyance screw 5 keeps rotating at a relatively high speed to maintain a high ratio of the rotational speed to the rotational speed of the second conveyance screw 6. In other words, when the first mode (a high speed mode) is changed to the second mode (a low speed mode), control is performed so that a speed change amount (a change amount of 0 rpm in the present exemplary embodiment) of the first conveyance screw 5 is smaller than a speed change amount (a change amount of 400 rpm in the present exemplary embodiment) of the second conveyance screw 6.

Accordingly, as indicated by an arrow B illustrated in FIG. 11, the amount of a developer B moving from the developing chamber 3 to the agitation chamber 4 increases. On the other hand, the mount of a developer C moving from the developing chamber 3 to the agitation chamber 4 by the developing sleeve 8 decreases. The amount of decrease in the developer C is larger than the amount of increase in the developer B. Further, as the rotational speed of the second conveyance screw 6 decreases, the amount of a developer A scooped up from the agitation chamber 4 into the developing chamber 3 decreases accordingly. The particle surface balance at 300 mm/s can be maintained at a point where the increase and decrease in the amounts of the developers A, B, and C are balanced.

As a result, when the sheet-passing speed is changed, the developer circulation balance in the developer container can be maintained as well, by maintaining the rotational speed of the first conveyance screw 5 or suppressing decrease in the rotational speed thereof.

Next, an effect of the present exemplary embodiment will be described below.

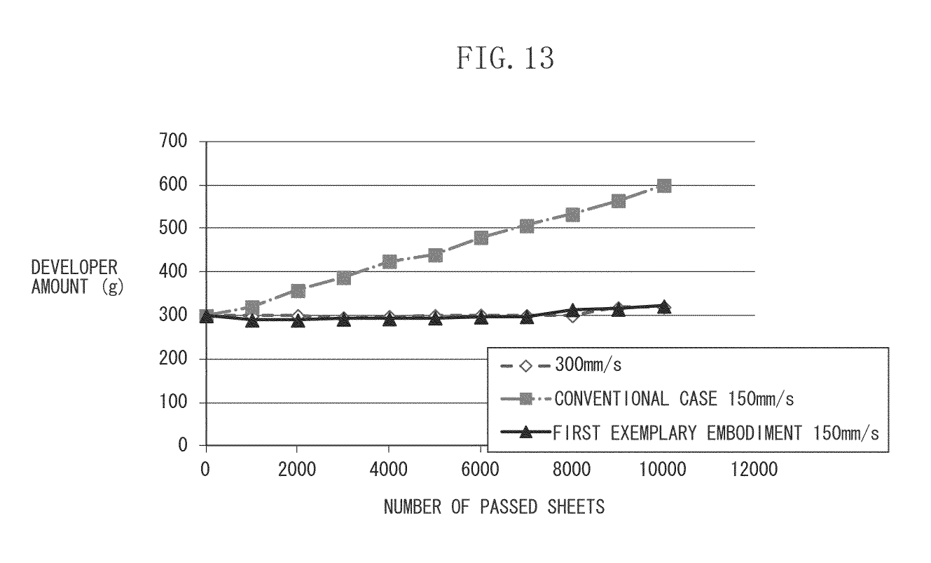

FIG. 13 illustrates a relation between the number of sheets which have passed through with an image printed on the entire surface of A4 paper and a developer weight. The toner amount required to perform printing on the entire surface of A4 paper is 0.29 g, and the supplied toner contains a carrier in 10% rate. In other words, if a 0.29-g toner is supplied, a 0.032-g carrier is supplied at the same time.

At the 300 mm/s sheet-passing speed, the developer amount increases only to about 320 g after passage of 10,000 sheets. On the other hand, in the case of the conventional developing unit in which the developer bearing member 8 and agitation screws 5 and 6 are driven by the same single drive source, at the 150 mm/s sheet-passing speed, the developer amount monotonically increases along with the increase in the number of passed sheets, and reaches as large as 600 g after passage of 10,000 sheets. The 600 g developer amount means that the developer amount has increased by 300 g for 10,000 sheets, which is substantially the same as the supplied carrier amount. This indicates that the conventional method discharges almost no developer in spite of the increase in the developer amount.

On the other hand, in the case of the present exemplary embodiment, the developer amount hardly increases even at the 150 mm/s sheet-passing speed (half speed). In other words, at the half speed, the developer amount indicates substantially the same transition as that at the 300 mm/s sheet-passing speed.

As described above, using the development drive source configuration according to the present exemplary embodiment can prevent the developer from excessively increasing during the low-speed operation even if the first conveyance screw 5 having no blades in the vicinity of the developer discharge port 13 is used.

If the driving speed of the developing sleeve 8 is extremely reduced as described below, the driving speed of the second conveyance screw 6 will extremely decrease accordingly. In the case of a vertical agitation type developing device in which a developing chamber and an agitation chamber are disposed at the upper and lower positions, respectively, as in the present exemplary embodiment, it is difficult to scoop up the developer from the agitation chamber 4 into the developing chamber 3. As a result, the developer surface in the developing chamber 3 is lowered. Accordingly, even if the rotational speed of the first conveyance screw 5 is maintained constant, the dischargeability degrades, and in some cases, the developer amount may increase to an extreme extent. Therefore, there is provided a lower limit of the driving speed which can be set to the second conveyance screw 6. In the present exemplary embodiment, a lower limit (tolerance) of the driving speed of the second conveyance screw 6 is set in the following way.

Specifically, the driving speed of the second conveyance screw 6 (image forming speed) is set within a range in which a developer increase amount in an image forming mode, in which a driving speed of the developing sleeve is the lowest, becomes 50% or less with reference to a developer amount in the developing device in an image forming mode, in which a driving speed of the developing sleeve is the highest. More specifically, in the present exemplary embodiment, the driving speed of the second conveyance screw 6 (image forming speed) is set so that a developer amount would be 450 g or less at 150 mm/s with reference to a developer amount of 300 g at 300 mm/s.

Setting the driving speed of the second conveyance screw 6 in this way can prevent the state caused in the conventional case, that is, at the 150 mm/s speed (half speed), the dischargeability degrades, and the developer amount monotonically increases along with the increase in the number of passed sheets, and reaches 600 g (100% increase rate) after passage of 10,000 sheets.

As the developer amount measurement method, the developer amount which becomes stabilized after continuous passage of images having a 5% image ratio at each driving speed is defined as the developer amount.

Although, in the present exemplary embodiment, the description has been given of a case where the rotational speed of the first conveyance screw 5 is maintained constant, the rotational speed of the first conveyance screw 5 is not limited thereto. For example, when the rotational speeds of the developing sleeve 8 and the second conveyance screw 6 decrease along with decrease in image forming speed (sheet-passing speed), the rotational speed of the first conveyance screw 5 may be changed to maintain the circulation balance in the developing device 1. However, in this case, along with the decrease in the image forming speed, the first conveyance screw 5 rotates at a relatively high rotational speed to maintain a high ratio of the rotational speed to the rotational speed of the second conveyance screw 6.

In the present exemplary embodiment, the description has been given using an example in which the developer discharge port 13 is provided in the developing chamber 3. Nevertheless, when the developer discharge port 13 is provided in the agitation chamber 4, the developing sleeve 8 and the first conveyance screw 5 will be driven by the same single drive source, and the second conveyance screw 6 will be driven by another drive source. In other words, it is sufficient that the conveyance screw in the chamber in which the developer discharge port 13 is provided is driven by a different drive source from that for driving the developing sleeve 8.

In the present exemplary embodiment, the description has been given of a configuration in which a conveyance screw having blades partially omitted in the vicinity of the developer discharge port 13 is used to prevent the developer from splashing and thereby being discharged. However, a similar effect can be obtained by using a conveyance screw partially having small blades in the area facing the developer discharge port 13. In other words, a similar effect can be obtained when blades facing the developer discharge port 13 have a smaller diameter than that of blades in the front and rear areas in the conveyance direction. Ribs or the like having a small diameter may be provided in the area facing the developer discharge port 13.

In addition, the area where no blades are formed, or the area where blades have a small diameter may not necessarily be provided at a position facing the developer discharge port 13. The area where no blades are formed may be provided at a position (an area corresponding to the developer discharge port 13) which is slightly deviated forward or backward in the conveyance direction according to a direction in which the developer splashes by the blades of the conveyance screw.

Although, in the present exemplary embodiment, a vertical agitation function-separated type developing device has been described as an example, the developing device is not limited thereto. The present exemplary embodiment is also applicable to a horizontal agitation function-separated type developing device in which the developing chamber 3 and the agitation chamber 4 are horizontally disposed, and a function-separated type developing device in which the developing chamber 3 and the agitation chamber 4 are diagonally disposed. Further, the present exemplary embodiment is also applicable to a function-separated type developing device in which the developing chamber 3 and the agitation chamber 4 are disposed in a vertically reverse way.

Although, in the present exemplary embodiment, the description has been given using an example in which the image forming apparatus is provided with two different image forming speeds, the image forming apparatus may be provided with three or more image forming speeds. In this case, it is sufficient that the difference in the stabilized developer amount between the highest image forming speed mode and the lowest image forming speed mode is 50% or less.

The first exemplary embodiment has proposed that, when the image forming apparatus is operated at the half speed, the rotational speeds of the developer bearing member 8 and the second conveyance screw 6 are set to the half speed similarly to the main body, and the rotational speed of the first conveyance screw 5 is fixed to the value at the normal speed.

However, some image forming apparatuses are provided with a further lower speed, namely, the ⅓ speed. The following describes a case where the configuration according to the first exemplary embodiment is used when the operating speed of the main body is too low.

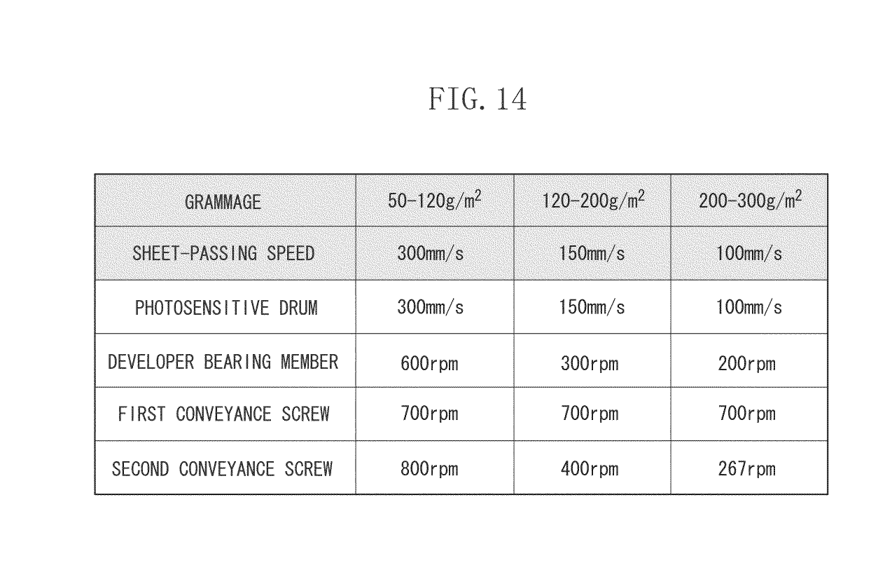

FIG. 14 illustrates a relation between driving speeds and rotational speeds at the ⅓ speed. Similar to the first exemplary embodiment, the rotational speed of the first conveyance screw 5 is constantly fixed, and the other members are changed with a similar ratio to the sheet-passing speed of the main body.

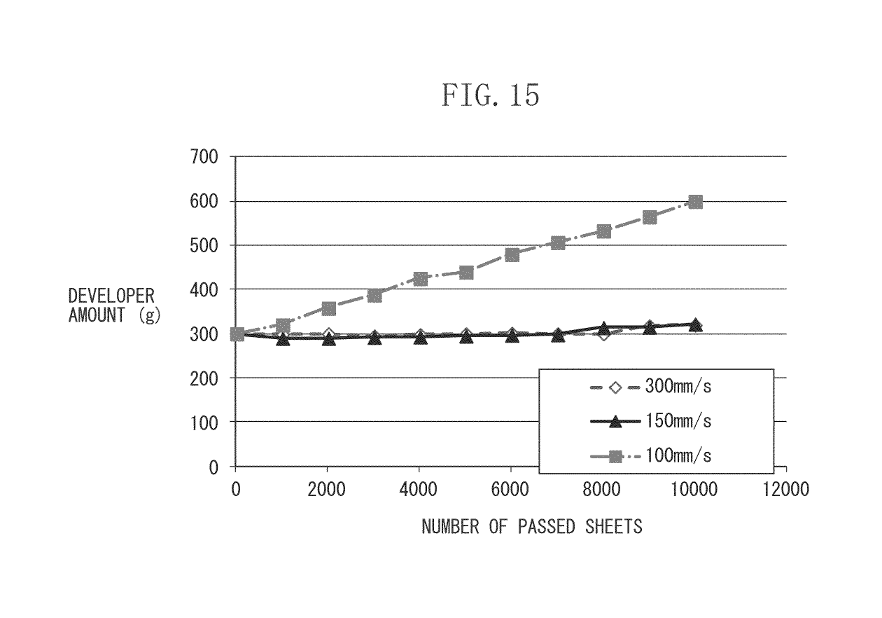

FIG. 15 illustrates a relation between the number of sheets which have passed through with an image printing on the entire surface of A4 paper and a developer weight, based on the settings illustrated in FIG. 14.

As described in the first exemplary embodiment, at the half speed (150 mm/s), the developer amount changes similarly to that at the normal speed (300 mm/s). On the other hand, when the sheets are passed through the main body at the 100 mm/s with the configuration according to the first exemplary embodiment, the developer amount monotonically increases.

The monotonic increase in the developer amount results from an extremely low rotational speed of 267 rpm of the second conveyance screw 6. As described in the first exemplary embodiment, the vertical agitation type developing unit scoops up the developer from the agitation chamber 4 into the developing chamber 3 against gravity. Therefore, if the rotational speed of the second conveyance screw 6 is extremely low, it becomes difficult to scoop up the developer into the developing chamber 3 against gravity. Then, the entire particle surface in the developing chamber 3 is lowered, and the developer surface in the vicinity of the developer discharge port 13 is also lowered. As a result, even if the developer amount in the developer container increases, the developer is hardly discharged.

In this way, in the configuration of the first exemplary embodiment in which the rotational speed of the first conveyance screw 5 is maintained constant, the developer amount can be stabilized up to the half sheet-passing speed. However, when the sheet-passing speed is extremely low as in the case of the ⅓ speed, the dischargeability extremely degrades and, consequently, the developer amount in the developing device may change in some cases.

In a second exemplary embodiment, the above-described issue will be solved by using the following method.

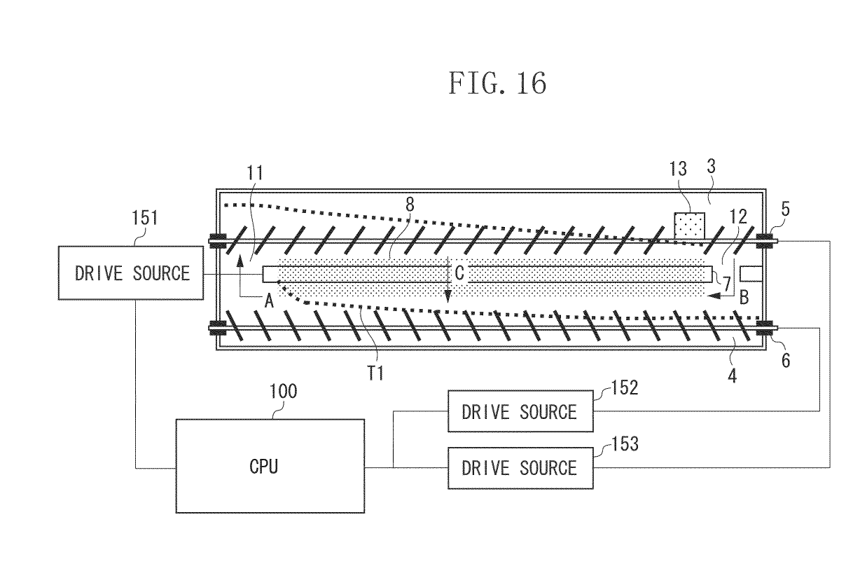

FIG. 16 illustrates a developing unit and a development drive source configuration according to the second exemplary embodiment.

In the present exemplary embodiment, the developing sleeve (also referred to as a developer bearing member) 8, the first conveyance screw 5, and the second conveyance screw 6 are driven by respective independent drive sources. More specifically, the developing unit includes drive sources 151 to 153 and a CPU 100 for controlling them.

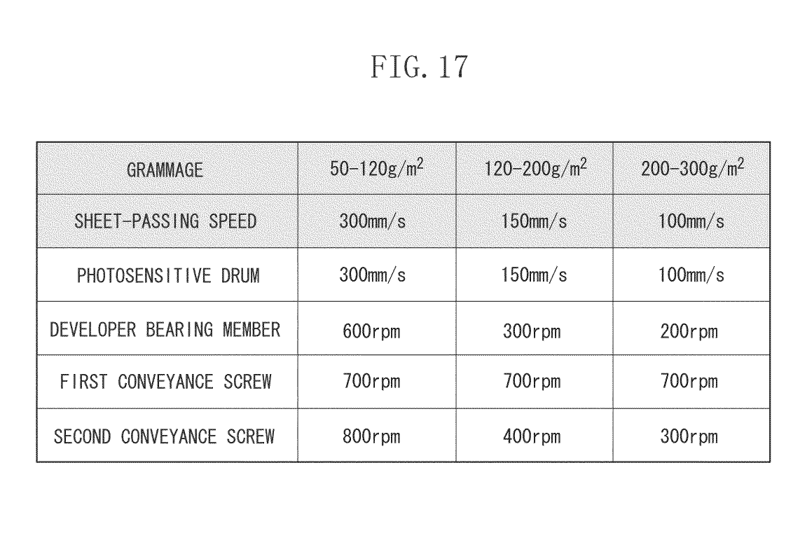

FIG. 17 illustrates a relation between the driving speeds and the rotational speeds of development members according to present exemplary embodiment.

In the present exemplary embodiment, the rotational speeds of the developing sleeve 8, the first conveyance screw 5, and the second conveyance screw 6 are controlled by the CPU 100 in the following way. When the sheet-passing speed is the normal speed (300 mm/s) or the half speed (150 mm/s), the above-described rotational speeds have the same values as those according to the first exemplary embodiment, whereas when the sheet-passing speed is the ⅓ speed (100 mm/s), the rotational speed of the second conveyance screw 6 is a rotational speed faster than 267 rpm which is one third of the normal speed.

This is because, if the rotational speed of the second conveyance screw 6 is too low, the developer cannot be scooped up from the agitation chamber 4 into the developing chamber 3, as described above.

Next, an effect of the present exemplary embodiment will be described below in a similar way to the one according to the first exemplary embodiment.

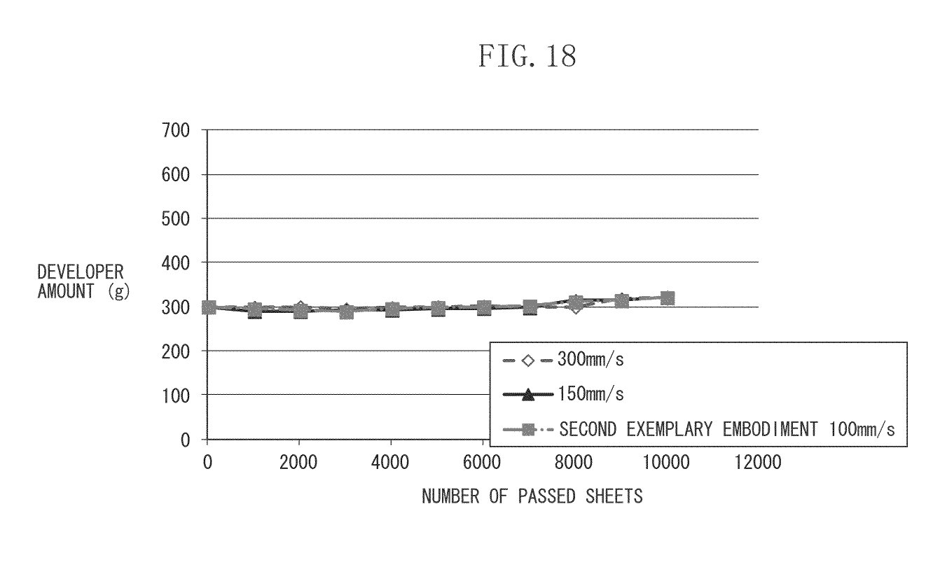

FIG. 18 illustrates a relation between the number of sheets which have passed through with an image printed on the entire surface of A4 paper and a developer weight according to the present exemplary embodiment.

In the configuration of the present exemplary embodiment, the increase in the developer amount as in the case of the configuration of the first exemplary embodiment, as illustrated in FIG. 15, is not seen even at the ⅓ speed (100 mm/s).

As described above, in the development drive source configuration according to the present exemplary embodiment, in a case where the first conveyance screw 5 having no blades in the vicinity of the developer discharge port 13 is used and even if the sheet-passing speed of the main body is extremely low, excessive increase in the developer amount can be prevented.

Furthermore, in the present exemplary embodiment, the description has been given of the configuration in which the rotational speed of the first conveyance screw 5 is fixed to 700 rpm which is exactly the same as the value in the normal speed mode. Nevertheless, the rotational speed of the first conveyance screw 5 may be reduced. In this case, however, similar to the first exemplary embodiment, it is necessary to make setting so that the amount of change in the developer amount in the developing device becomes 50% or less when the image forming speed is changed from the highest speed (normal speed) to the lowest speed (⅓ speed).

In the present exemplary embodiment, the description has been given of a configuration in which a conveyance screw having blades partially omitted in the vicinity of the developer discharge port 13 is used to prevent the developer from splashing and thereby being discharged. However, a similar effect can be obtained if small blades or ribs are provided at the relevant portion.

The present exemplary embodiment has proposed that the developer bearing member 8, the first conveyance screw 5, and the second conveyance screw 6 are driven by respective independent drive sources. However, this configuration has a drawback that the number of drive motors excessively increases in an existing system.

Therefore, on the premise that the peripheral speed ratio of the developer bearing member 8 and the photosensitive drum 10 is constant, the developer bearing member 8 and the photosensitive drum 10 may be driven by the same single drive source, and the first conveyance screw 5 and the second conveyance screw 6 may be separately driven by respective independent drive sources.

Although the present exemplary embodiment has been described above based on the vertical agitation type function-separated configuration as an example, the configuration of the present invention is not limited thereto. For example, the present invention is also applicable to a so-called horizontal agitation type function-separated configuration, in which the first conveyance screw 5 and the second conveyance screw 6 are disposed so as to overlap with each other when seen from a horizontal direction.

According to an exemplary embodiment of the present invention, it is possible to provide a developing device including a discharge port for discharging a developer, and a conveyance member having no blades or having small-diameter blades at a discharge port counter portion, and having separated functions of supplying the developer and collecting the developer to/from a developer bearing member, the developing device capable of suppressing a decrease in the dischargeability of the developing device even if the driving speed of the developing device is changed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-267131 filed Dec. 25, 2013, which is hereby incorporated by reference herein in its entirety.

What is claimed is:

1. An image forming apparatus capable of executing a first mode in which an image forming speed is a first speed, and a second mode in which an image forming speed is a second speed lower than the first speed, the image forming apparatus comprising:
an image bearing member rotatably disposed, and configured to bear an image;
a developer bearing member rotatably disposed, and configured to bear a developer containing toner and a carrier to develop a latent image formed on the image bearing member;
a first chamber configured to supply the developer to the developer bearing member at a position facing the developer bearing member;
a second chamber connected with the first chamber to form a circulation path for circulating the developer between the first and second chambers, and configured to collect the developer from the developer bearing member at a position facing the developer bearing member;
a partition wall separating the first and the second chambers;
a discharge port configured to discharge the developer in a developing device;
a first conveyance member rotatably disposed in the first chamber so as to face the discharge port, and configured to convey the developer in the first chamber,
wherein the first conveyance member has no blade in an area corresponding to the discharge port, or a diameter of blades in the area is smaller than that of blades in front and rear areas in a conveyance direction;
a second conveyance member rotatably disposed in the second chamber, and configured to convey the developer in the second chamber;
a first drive source configured to drive the first conveyance member;
a second drive source configured to drive the second conveyance member; and
a control unit configured to control the first and the second drive sources so that, when the first mode is changed to the second mode, a speed change amount of the first conveyance member is smaller than a speed change amount of the second conveyance member.

2. The image forming apparatus according to claim 1, wherein, when the first mode is changed to the second mode, the control unit performs control to reduce a rotational speed of the second conveyance member without changing a rotational speed of the first conveyance member.

3. The image forming apparatus according to claim 1,
wherein the first mode is a mode in which an image forming speed is highest, and the second mode is a mode in which an image forming speed is lowest, and
wherein the control unit controls a speed ratio of the first and the second conveyance members so that a change amount of a developer amount in the developing device in the second mode becomes 50% or less with reference to a developer amount in the developing device in the first mode.

4. An image forming apparatus capable of executing a first mode in which an image forming speed is a first speed, and a second mode in which an image forming speed is a second speed lower than the first speed, the image forming apparatus comprising:
an image bearing member rotatably disposed, and configured to bear an image;
a developer bearing member rotatably disposed, and configured to bear a developer containing toner and a carrier to develop a latent image formed on the image bearing member;
a first chamber configured to supply the developer to the developer bearing member at a position facing the developer bearing member;
a second chamber connected with the first chamber to form a circulation path for circulating the developer between the first and second chambers, and configured to collect the developer from the developer bearing member at a position facing the developer bearing member;
a partition wall separating the first and the second chambers;
a discharge port configured to discharge the developer in a developing device;
a first conveyance member rotatably disposed in the first chamber, and configured to convey the developer in the first chamber;
a second conveyance member rotatably disposed in the second chamber so as to face the discharge port, and configured to convey the developer in the second chamber,
wherein the second conveyance member has no blade in an area corresponding to the discharge port, or a diameter of blades in the area is smaller than that of blades in front and rear areas in a conveyance direction;
a first drive source configured to drive the first conveyance member;
a second drive source configured to drive the second conveyance member; and
a control unit configured to control the first and the second drive sources so that, when the first mode is changed to the second mode, a speed change amount of the second conveyance member is smaller than a speed change amount of the first conveyance member.

5. The image forming apparatus according to claim 4, wherein, when the first mode is changed to the second mode, the control unit performs control to reduce a rotational speed of the first conveyance member without changing a rotational speed of the second conveyance member.

6. The image forming apparatus according to claim 4,
wherein the first mode is a mode in which an image forming speed is highest, and the second mode is a mode in which an image forming speed is lowest, and
wherein the control unit controls a speed ratio of the first and the second conveyance members so that a change amount of a developer amount in the developing device in the second mode becomes 50% or less with reference to a developer amount in the developing device in the first mode.
